(19) United States
(12) Patent Application Publication
(10) Pub. No.: US 2026/0328174 A1
(43) Pub. Date: Oct. 22, 2026

(54) COMPUTER, SYSTEM AND METHOD FOR SYNCHRONIZING AN INTERNAL COMBUSTION ENGINE USING A CAMSHAFT TARGET

(71) Applicant: Shaeffler Technologies AG & Co. KG, Herzogenaurach (DE)

(72) Inventors: Stéphane ELOY, Toulouse (FR); Fabien JOSEPH, Toulouse (FR)

(21) Appl. No.: 19/109,479

(22) PCT Filed: Sep. 22, 2023
(86) PCT No.: PCT/EP2023/076179

§ 371 Date: Mar. 6, 2025

(30) Foreign Application Priority Data
Sep. 28, 2022 (FR) FR2209813

(51) Int. Cl. F02N 11/08

(52) U.S. Cl. CPC F02N 11/08; F02N 2200/021

(57) ABSTRACT

The invention relates to a computer for a system for synchronizing an internal combustion engine, said system comprising a camshaft provided with a target having a plurality of unevenly distributed teeth, and a camshaft sensor. The computer receives a signal generated by the camshaft sensor, and calculates time intervals Tₙ separating two rising edges, or falling edges respectively, immediately succeeding each other in said signal.

The computer further comprises three discrimination modules, each performing:
a calculation of a current value of a respective actual ratio that is a function of a respective set of time intervals Tₙ;
a comparison with intervals that are each a function of the value of a corresponding theoretical ratio, where the definition of the theoretical ratio is similar to the definition of the actual ratio but expressed as a function of angular intervals between the teeth of the target, and where each value of the theoretical ratio corresponds to a given hypothesis relating to an index of the tooth currently located facing the sensor; and
as a function of the result of the comparison, a discrimination between tooth indices that can or cannot correspond to the tooth located in front of the sensor.

### TECHNICAL FIELD

The invention relates to the field of synchronizing an internal combustion engine using a camshaft target of said engine.

### PRIOR ART

An internal combustion engine must be phased, or synchronized, in order to determine and optimize the best time to burn the fuel in the cylinder, that is, to optimize fuel consumption in particular.

Throughout this document, synchronization means determining the angular position of the internal combustion engine during the combustion cycle.

Phasing, or synchronization, is generally achieved by combining two pieces of information from a crankshaft sensor and a camshaft sensor.

The crankshaft sensor interacts, in a manner known per se, with a crankshaft target. The crankshaft target is rigidly mounted on the crankshaft. It is generally disk-shaped, with a plurality of evenly spaced teeth on its periphery, and an asymmetry. This asymmetry, or signature, generally takes the form of one or two missing teeth on the periphery of the crankshaft target, and makes it possible to know what position the engine is in, to within 360°. The position of the crankshaft target is determined using the crankshaft sensor, which detects times when the teeth pass in front of said crankshaft sensor.

During one rotation of the engine, the crankshaft rotates twice, whereas the camshafts rotate only once.

An additional piece of information is therefore obtained using the camshaft sensor. The camshaft sensor interacts, in a manner known per se, with a disk-shaped camshaft target that is rigidly mounted on the camshaft. The camshaft target has teeth on its periphery, with the teeth optionally unevenly distributed. In particular, the teeth can be unevenly spaced and/or of different lengths (the length of a tooth corresponding to its angular span along the perimeter of the camshaft target). The camshaft target thus has an asymmetry, which makes it possible to achieve correct phasing, that is, to determine with certainty where each cylinder is placed in the combustion cycle. The position of the camshaft target is read by the camshaft sensor, which detects times when the teeth pass in front of said camshaft sensor.

In practice, the camshaft sensor generates a signal that adopts a low value in the absence of a tooth in front of the sensor, and a high value in the presence of a tooth in front of said sensor.

The transition between the low value and the high value of the signal forms a rising edge of the signal, associated with the detection of a rising edge of a tooth of the camshaft target. The transition between the high value and the low value of the signal forms a falling edge of the signal, associated with the detection of a falling edge of a tooth of the camshaft target.

The synchronization methods according to the prior art consist in comparing information obtained using the camshaft sensor with information obtained using the crankshaft sensor, so as to determine the position of the engine.

However, the methods are based on recognition of the signature of the crankshaft target, which means that they are ineffective in the event of failure of the crankshaft sensor.

Another synchronization method must then be implemented, based on the identification of the tooth of the camshaft target that is in front of the camshaft sensor.

This other synchronization method is based on the measurement of time intervals separating rising edges (or falling edges respectively) of the signal generated by the camshaft sensor, and on the use of ratios between several of these measured time intervals.

As is known per se, the synchronization is then based on the use of an actual ratio N, defined by:

N=(Tₙ+Tₙ₋₃)/(Tₙ₋₁+Tₙ₋₂),
where Tₙ relates to the last time interval measured between two rising edges (or falling edges respectively) of the camshaft signal (in other words, the index n relates to the most recent rising edges, or falling edges respectively in the signal generated by the camshaft sensor);
where Tₙ₋₁ relates to the time interval immediately preceding the time interval Tₙ, in the signal generated by the camshaft sensor;
where Tₙ₋₂ relates to the time interval immediately preceding the time interval Tₙ₋₁, in the signal generated by the camshaft sensor; and
where Tₙ₋₃ relates to the time interval immediately preceding the time interval Tₙ₋₂, in the signal generated by the camshaft sensor.

The synchronization method also uses a theoretical ratio Rₜₕ, defined by:

Rₜₕ=(αₚ+αₚ₋₃)/(αₚ₋₁+αₚ₋₂),
where αₚ relates to the angular separation between the two rising tooth edges (or falling tooth edges respectively) of the camshaft target, associated with the edges of the signal defining the time interval Tₙ;
where αₚ₋₁ relates to the angular separation between the two rising tooth edges (or falling tooth edges respectively) of the camshaft target, associated with the edges of the signal defining the time interval Tₙ₋₁;
where αₚ₋₂ relates to the angular separation between the two rising tooth edges (or falling tooth edges respectively) of the camshaft target, associated with the edges of the signal defining the time interval Tₙ₋₂;
where αₚ₋₃ relates to the angular separation between the two rising tooth edges (or falling tooth edges respectively) of the camshaft target, associated with the edges of the signal defining the time interval Tₙ₋₃.

The theoretical ratio Rₜₕ is therefore a ratio based on known angular separations between tooth edges of the camshaft target.

The actual ratio N is an equivalent ratio, but based on measurements of time interval in the signal generated by the camshaft sensor.

Each tooth of the camshaft target is denoted by its index i, where i is an integer from 1 to P the number of teeth on the camshaft target.

The synchronization method according to the prior art is then based on:
calculating the value of the theoretical ratio Rₜₕ, for each of a plurality of possible hypotheses relating to the index of the tooth of the camshaft target currently located facing the camshaft sensor, and
comparing the different values of the theoretical ratio Rₜₕ calculated in this way with the measured current value of the actual ratio N.

It is thus possible to gradually eliminate the least realistic hypotheses, until only one plausible value remains for the index of the tooth of the camshaft target currently located facing the sensor. Throughout this document, a hypothesis relates to the index of the tooth of the camshaft target currently located facing the camshaft sensor.

In order to take into account the irregularities of the engine, and/or the variations in acceleration on starting, it is usual to compare the actual ratio N with a range of values of the theoretical ratio Rₜₕ. In other words, a hypothesis is considered to be plausible when N belongs to said range of values of the theoretical ratio Rₜₕ. This range of values is defined by a tolerance factor k, and extends from a lower bound V_{inf}=Rₜₕ/k to Vₛᵤₚ=Rₜₕ*k.

The main drawback of this method is the slowness of synchronizing the internal combustion engine, as the camshaft sensor must detect at least five to six rising tooth edges, or falling tooth edges respectively, before synchronization can be achieved.

Defining the theoretical ratio Rₜₕ requires having the measurement of four time intervals between two rising tooth edges, or falling tooth edges respectively, to be able to calculate this ratio. Five rising tooth edges, or falling tooth edges respectively, must therefore be detected to be able to start analyzing the ratios. Taking into account the tolerance factor k, and the geometry of the camshaft targets, which can have the same angular separation between two adjacent teeth several times, there are often several plausible hypotheses remaining after the fifth tooth edge for the index of the tooth currently located facing the sensor.

By way of example, for a three-cylinder engine, the internal combustion engine takes approximately 460 ° C RK (crankshaft rotation angle, in °) to synchronize when the crankshaft sensor and the camshaft sensor are operational, while if the crankshaft sensor is defective, synchronization based on the method described above will take more than 1000 ° C RK. On this engine, considering a starter speed of 200 rpm, that gives 450 ms of delay on starting. This additional time is very noticeable to the driver.

In the event of the failure or absence of the crankshaft sensor, the synchronization method of the prior art is therefore far too long. In addition, the starter must be activated for a long time, which also leads to excessive electricity consumption, and the first combustions are delayed.

### DISCLOSURE OF THE INVENTION

The invention aims to improve synchronization performance when the crankshaft sensor is defective, and to limit fuel consumption.

To this end, the invention relates to a computer for a system for synchronizing an internal combustion engine, said system comprising:
a camshaft provided with a camshaft target, the camshaft target having a plurality of teeth unevenly distributed on its perimeter, each tooth being associated with a predetermined index making it possible to identify it; and
a camshaft sensor, configured to detect the passing of the teeth, and to generate in response a signal comprising rising edges and falling edges respectively associated with rising edges and falling edges of the teeth;
said computer comprising an acquisition and pre-processing module, configured to acquire the signal generated by the camshaft sensor, and to calculate time intervals Tₙ separating two rising edges, or falling edges respectively, immediately succeeding each other in said signal.
   The computer further comprises
i/ a first discrimination module, configured for:
   determining a current value adopted by a first actual ratio N1 that is a function of a first set of time intervals Tₙ;
   comparing said current value of the first actual ratio N1 with each of a plurality of predetermined first intervals, each first interval being defined as a function of the respective value adopted by a first theoretical ratio Rₜₕ₁, where the definition of the first theoretical ratio Rₜₕ₁ is similar to the definition of the first actual ratio N1 except that the time intervals Tₙ are replaced by known corresponding angular separations between the rising edges or falling edges respectively of the teeth of the camshaft target, and where each value of the first theoretical ratio Rₜₕ₁ considered is associated with one of a plurality of predetermined hypotheses relating to the index of the tooth located in front of the camshaft sensor; and
   as a function of the result of the comparison, discriminating between tooth indices that can correspond to the index of the tooth located in front of the camshaft sensor, and tooth indices that cannot correspond to the index of the tooth located in front of the camshaft sensor;
ii/ a second discrimination module, configured for implementing the same steps as the first discrimination module, except that these steps use a second actual ratio N2 instead of the first actual ratio N1, and second intervals defined as a function of a second theoretical ratio Rₜₕ₂ instead of the first theoretical ratio Rₜₕ₁, where the second actual ratio N2 is a function of a second set of time intervals Tₙ, where the definition of the second theoretical ratio (Rₜₕ₂) is similar to the definition of the second actual ratio (N2) except that the time intervals Tₙ are replaced by known corresponding angular separations between the rising edges or falling edges respectively of the teeth of the camshaft target, and where the second set of time intervals contains a higher number of time intervals Tₙ than the first set of time intervals;
ii/ a third discrimination module, configured for implementing the same steps as the first discrimination module, except that these steps use a third actual ratio N3 instead of the first actual ratio N1, and third intervals defined as a function of a third theoretical ratio Rₜₕ₃ instead of the first theoretical ratio Rₜₕ₁, where the third actual ratio N3 is a function of a third set of time intervals Tₙ, where the definition of the third theoretical ratio Rₜₕ₃ is similar to the definition of the third actual ratio N3 except that the time intervals Tₙ are replaced by known corresponding angular separations between the rising edges or falling edges respectively of the teeth of the camshaft sensor, and where the third set of time intervals contains a higher number of time intervals Tₙ than the second set of time intervals; and
   an evaluation module, configured for receiving, from the first, second, and third discrimination modules and when it exists, data relating to the tooth indices that can or cannot correspond to the index of the tooth located in front of the camshaft sensor, and for comparing this data so as to deduce therefrom the index of the tooth located in front of the camshaft sensor.

In other words, the computer comprises three discrimination modules, each performing:
a calculation of a current value of a respective actual ratio that is a function of a respective set of time intervals Tₙ;
a comparison with one or more intervals defined as a function of respective values of a corresponding theoretical ratio, where the definition of the theoretical ratio is similar to the definition of the actual ratio but expressed as a function of angular intervals between the teeth of the target, and where each value of the theoretical ratio corresponds to a given hypothesis relating to an index of the tooth currently located facing the sensor; and
as a function of the result of the comparison, a discrimination between tooth indices that can or cannot correspond to the tooth located in front of the sensor.

The comparison between a current actual ratio value and a predetermined interval consists in determining whether said value is inside or outside said interval. When said value is inside the interval, the corresponding hypothesis relating to the index of the tooth located in front of the sensor is a hypothesis that is considered to be plausible. In other words, said tooth index is considered to be able to correspond to the index of the tooth located in front of the camshaft sensor. Conversely, when said value is outside the interval, the corresponding hypothesis relating to the index of the tooth located in front of the sensor is a hypothesis that is considered to be implausible. In other words, said tooth index is considered not to be able to correspond to the index of the tooth located in front of the camshaft sensor.

Over time, all of the hypotheses are eliminated apart from one. The invention thus makes it possible to determine which tooth of the target is in front of (that is, opposite, or facing) the camshaft sensor at all times. This determination defines the angular position of the camshaft target, and makes it possible to ultimately obtain the angular position of the internal combustion engine. The invention thus makes it possible to synchronize said engine.

Which tooth is located in front of the sensor is determined by elimination of the implausible hypotheses. Hypotheses are gradually eliminated because they are implausible, until only one hypothesis remains, which thus corresponds to the tooth located in front of the sensor.

The first discrimination module uses a small number of time intervals Tₙ, which allows it to quickly provide first discrimination results, in particular at the start of synchronization. In some cases, these first results can make it possible to determine directly which tooth is in front of the sensor.

The second discrimination module uses a higher number of time intervals Tₙ. It thus provides second discrimination results a little less quickly, but these results are often more discriminating. Combined with the first discrimination results, these second discrimination results can make it possible to determine directly which tooth is in front of the sensor. If applicable, they can make it possible to consolidate a first result relating to the tooth located in front of the sensor.

The third discrimination module uses an even higher number of time intervals Tₙ. It thus provides third discrimination results even less quickly, but these results are often even more discriminating. Combined with the first and second discrimination results, these third discrimination results can make it possible to determine which tooth is in front of the sensor. If applicable, they can make it possible to consolidate a result obtained previously, relating to the tooth located in front of the sensor.

Each module makes it possible to eliminate hypotheses considered to be implausible, independently of the other modules. Each module performs an independent discrimination, based on a different definition of the theoretical and actual ratios. Each module thus makes it possible to eliminate different hypotheses.

The concatenation of these results relating to the plausible or implausible hypotheses ultimately makes it possible to obtain both:
quick determination, when this is possible, of the tooth located in front of the sensor; and
a robust response, due to the use of several definitions of the theoretical and actual ratios, at least one of which is based on the use of a large number of time intervals Tₙ.

In addition, the invention makes it possible to use wide intervals for the comparisons, wider than in the prior art. This makes it possible to avoid estimation errors regarding the plausible or implausible hypotheses, in particular in the event of strong acceleration or deceleration. The use of wider intervals means that each discrimination module, taken individually, is less discriminating. However, by combining the three discrimination modules, strong discrimination is obtained. The invention thus makes it possible to quickly discriminate between plausible and implausible hypotheses, while avoiding errors in the evaluation of certain limit conditions, in particular in the event of strong acceleration or deceleration.

On starting, the tooth located in front of the sensor is not known. It is determined after a certain period of use of the computer according to the invention.

Advantageously, the computer is provided with a memory, for storing tooth indices previously identified as plausible or implausible, and the evaluation module is configured to take into account both these results stored in the memory and new results.

Preferably, the computer continues to be used even once it has determined the index of the tooth located in front of the sensor for a first time. The computer then compares the results supplied by each of the three discrimination modules, to check that these results are consistent with each other. If applicable, if these results are not consistent with each other, the computer according to the invention can be configured to run a new determination of the tooth located in front of the sensor. In other words, the synchronization is lost when the synchronization values are considered to be inconsistent, in order to run a new synchronization. This situation arises in particular when the engine is stopped, when a reverse rotation can occur.

Preferably, each first, second, or third interval respectively is delimited by a lower bound and an upper bound, where:
the lower bound is equal to the quotient of the respective value over the first, second, or third theoretical ratio (Rₜₕ₁, Rₜₕ₂, Rₜₕ₃) respectively, divided by a first, second, or third tolerance factor respectively; and
the upper bound is equal to the product of the respective value by the first, second, or third theoretical ratio (Rₜₕ₁, Rₜₕ₂, Rₜₕ₃) respectively, multiplied by the first, second, or third tolerance factor respectively.

In other words, for each value of the first, second, or third theoretical ratio respectively, an interval is defined the bounds of which are a function of said value of the theoretical ratio and a first, second, or third tolerance factor respectively. Said comparison consists in determining, for each of these intervals, whether the current value of the actual ratio (N1, N2, or N3 respectively) is inside or outside said interval. If said current value of the actual ratio is inside the interval, this means that a corresponding hypothesis relating to the tooth located in front of the sensor is a plausible hypothesis. Otherwise, the hypothesis is considered to be implausible, so it can be eliminated. Each interval is defined by a lower bound V_{inf} and an upper bound Vₛᵤₚ, where V_{inf}=Rₜₕ (i, j)/k(i) and Vₛᵤₚ=Tₜₕ(i, j)*k(i), where i=1, 2, or 3, for the first, second, or third theoretical ratio, or tolerance factor, respectively, and where j is the index of the tooth located in front of the sensor in the hypothesis under consideration.

Preferably, at least one of the first, second, or third tolerance factors respectively is greater than or equal to 2.3, or greater than or equal to 2.5, or even greater than or equal to 2.8.

Preferably, the computer further comprises a starting module, configured to generate an instruction to start the internal combustion engine when the index of the tooth located in front of the camshaft sensor is obtained as an output from the evaluation module.

Advantageously, each of the first, second, and third discrimination modules has a respective initiation period, which is a function of the number of time intervals Tₙ in the first, second, or third set of time intervals Tₙ respectively.

The first, second, and third discrimination modules are advantageously configured to operate together in parallel.

Preferably, the second actual ratio (N2) is defined by:

N2=(Tₙ₋₁*Tₙ₋₁)/(Tₙ*Tₙ₋₂),
where Tₙ relates to the last time interval in the signal received by the acquisition and pre-processing module;
where Tₙ₋₁ relates to the time interval immediately preceding the time interval Tₙ, in the signal received by the acquisition and pre-processing module;
where Tₙ₋₂ relates to the time interval immediately preceding the time interval Tₙ₋₁, in the signal received by the acquisition and pre-processing module.

Advantageously, the first actual ratio (N1) is defined by:

N1=Tₙ/Tₙ₋₁.

Preferably, the third actual ratio (N3) is defined by:

N3=(Tₙ+Tₙ₋₃)/(Tₙ₋₁+Tₙ₋₂), where Tₙ₋₃ relates to the time interval immediately preceding the time interval Tₙ₋₂, in the signal received by the acquisition and pre-processing module.

The invention also relates to a system for synchronizing an internal combustion engine, said system comprising:
a camshaft provided with a camshaft target, the camshaft target having a plurality of teeth unevenly distributed on its perimeter, each tooth being associated with a predetermined index making it possible to identify it; and
a camshaft sensor, configured to detect the passing of the teeth, and to generate in response a signal comprising rising edges and falling edges respectively associated with rising edges and falling edges of the teeth; and
a computer according to the invention.

The invention also relates to a method for determining the angular position of a camshaft target, where said camshaft target is rigidly mounted on a camshaft and has a plurality of teeth unevenly distributed on its perimeter, each tooth being associated with a predetermined index making it possible to identify it, the method comprising the following steps:
acquiring a signal generated by a camshaft sensor, said sensor being configured to detect the passing of the teeth of the camshaft target and to generate in response a signal comprising rising edges and falling edges respectively associated with rising edges and falling edges of the teeth; and
calculating the time intervals Tₙ separating two rising edges, or falling edges respectively, immediately succeeding each other in said signal.

According to the invention, the method further comprises the following steps:
i/ a first discrimination step, consisting in:
   determining the current value adopted by a first actual ratio (N1) that is a function of a first set of time intervals Tₙ;
   comparing said current value of the first actual ratio (N1) with each of a plurality of predetermined first intervals, each first interval being defined as a function of the respective value adopted by a first theoretical ratio (Rₜₕ₁), where the definition of the first theoretical ratio (Rₜₕ₁) is similar to the definition of the first actual ratio (N1) except that the time intervals Tₙ are replaced by known corresponding angular separations between the rising edges or falling edges respectively of the teeth of the camshaft target, and where each value of the first theoretical ratio (Rₜₕ₁) considered is associated with one of a plurality of predetermined hypotheses relating to the index of the tooth located in front of the camshaft sensor; and
   as a function of the result of the comparison, discriminating between tooth indices that can correspond to the index of the tooth located in front of the camshaft sensor, and tooth indices that cannot correspond to the index of the tooth located in front of the camshaft sensor;
ii/ a second discrimination step, implementing the same steps as the first discrimination step, except that these steps use a second actual ratio (N2) that is a function of a second set of time intervals Tₙ, and second intervals defined as a function of a second theoretical ratio (Rₜₕ₂), where the definition of the second theoretical ratio (Rₜₕ₂) is similar to the definition of the second actual ratio (N2) except that the time intervals Tₙ are replaced by known corresponding angular separations between the rising edges or falling edges respectively of the teeth of the camshaft target, and where the second set of time intervals contains a higher number of time intervals Tₙ than the first set of time intervals;
iii/ a third discrimination step, implementing the same steps as the first discrimination module, except that these steps use a third actual ratio (N3) that is a function of a third set of time intervals Tₙ, and third intervals defined as a function of a third theoretical ratio (Rₜₕ₃), where the definition of the third theoretical ratio (Rₜₕ₃) is similar to the definition of the third actual ratio (N3) except that the time intervals Tₙ are replaced by known corresponding angular separations between the rising edges or falling edges respectively of the teeth of the camshaft target, and where the third set of time intervals contains a higher number of time intervals Tₙ than the second set of time intervals;
the method then comprising an evaluation step consisting in comparing, when it exists, data relating to the tooth indices that can or cannot correspond to the index of the tooth located in front of the camshaft sensor, this data being obtained in the first, second, and third discrimination steps, and deducing therefrom the index of the tooth located in front of the camshaft sensor.

Advantageously, each first, second, or third interval respectively is delimited by a lower bound and an upper bound, where:
the lower bound is equal to the quotient of the respective value over the first, second, or third theoretical ratio (Rₜₕ₁, Rₜₕ₂, Rₜₕ₃) respectively, divided by a first, second, or third tolerance factor respectively; and
the upper bound is equal to the product of the respective value by the first, second, or third theoretical ratio (Rₜₕ₁, Rₜₕ₂, Rₜₕ₃) respectively, multiplied by the first, second, or third tolerance factor respectively.

At least one of the first, second, or third tolerance factors respectively is advantageously greater than or equal to 2.3.

Preferably, the method further comprises a step of generating an instruction to start the internal combustion engine, when the index of the tooth located in front of the camshaft sensor has been determined in the preceding steps.

Advantageously, each of the first, second, and third discrimination steps has a respective initiation period, which is a function of the number of time intervals Tₙ in the first, second, and third set of time intervals Tₙ respectively.

Preferably, the first, second, and third discrimination steps are implemented in parallel.

Advantageously, the second actual ratio (N2) is defined by:

N2=(Tₙ₋₁*Tₙ₋₁)/(Tₙ*Tₙ₋₂),
where Tₙ relates to the last time interval acquired, in the signal acquired from the camshaft sensor;
where Tₙ₋₁ relates to the time interval immediately preceding the time interval Tₙ, in the signal acquired from the camshaft sensor;
where Tₙ₋₂ relates to the time interval immediately preceding the time interval Tₙ₋₁, in the signal acquired from the camshaft sensor.

Preferably, the first actual ratio (N1) is defined by:

N1=Tₙ/Tₙ₋₁.

Advantageously, the third actual ratio (N3) is defined by:

N3=(Tₙ+Tₙ₋₃)/(Tₙ₋₁+Tₙ₋₂), where Tₙ₋₃ relates to the time interval immediately preceding the time interval Tₙ₋₂, in the signal acquired from the camshaft sensor.

The invention also relates to a computer program product, comprising program code instructions for carrying out the steps of the synchronization method as claimed in any one of claims 8 to 12 when said program is operating on a computer.

Finally, the invention relates to a motor vehicle comprising a synchronization system according to the invention.

### DESCRIPTION OF THE FIGURES

Further features and advantages of the invention will become more apparent upon reading the following description. This description is purely illustrative and should be read with reference to the appended drawings, in which:

FIG. 1 schematically illustrates a synchronization system according to the invention;

FIG. 2 schematically illustrates a camshaft target in the synchronization system in FIG. 1;

FIG. 3 schematically illustrates a signal generated by the camshaft sensor, in the synchronization system in FIG. 1;

FIG. 4 schematically illustrates the computer in the synchronization system in FIG. 1; and

FIG. 5 schematically illustrates a method according to the invention.

### DETAILED DESCRIPTION OF AT LEAST ONE EMBODIMENT

The invention relates to a computer for a system for synchronizing an internal combustion engine.

Said computer can form part of a controller placed on board a motor vehicle.

The system for synchronizing the internal combustion engine comprises in particular a camshaft that is provided with a camshaft target, rigidly mounted on the camshaft and having a plurality of teeth. The teeth are unevenly distributed on the circular perimeter of the target. Preferably, the teeth are all the same width, and are unevenly spaced part from each other.

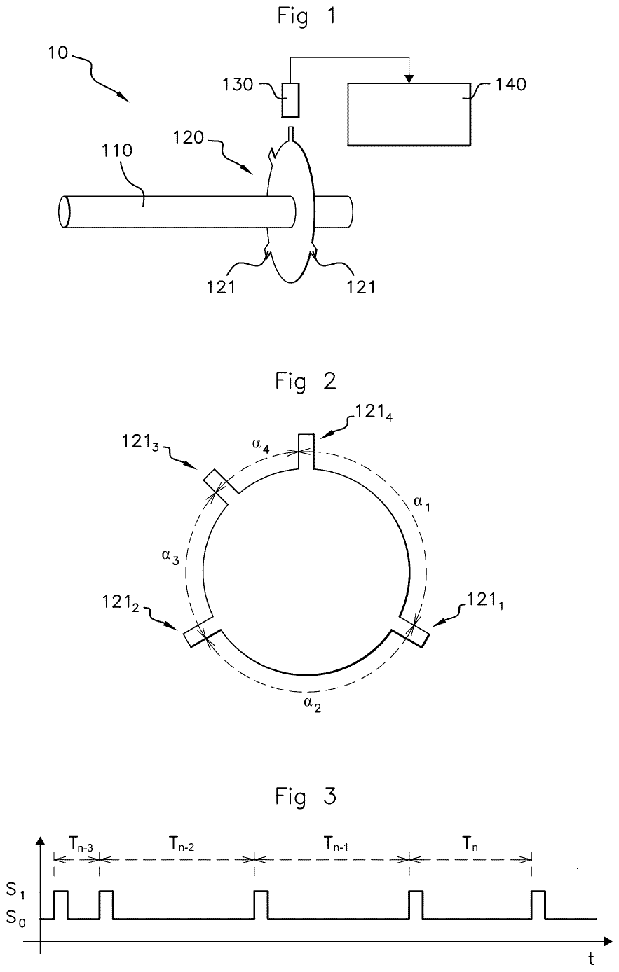

FIG. 1 schematically illustrates a synchronization system 10 according to the invention. The system 10 comprises:
a camshaft 110 provided with a camshaft target 120 having a plurality of teeth 121 unevenly distributed on the circular outer perimeter of said target;
a camshaft sensor 130, configured to detect the passing of the teeth 121 of the target; and
a computer 140, as described below.

FIG. 2 illustrates in greater detail an example of a camshaft target 120 according to the invention. Here, the target comprises four teeth 121. Not all of the teeth 121 have the same dimensions, with intervals between two adjacent teeth that are not the same around the whole perimeter of the target.

The topology of the perimeter of the target can adopt two values: a low value, where there is no tooth, and a high value, where there is a tooth. The interface between a zone adopting the low value and a zone adopting the high value forms a rising tooth edge. Similarly, the interface between a zone adopting the high value and a zone adopting the low value forms a falling tooth edge.

Each tooth 121 is associated with an index i=1 to 4, which makes it possible to identify it. Here, the target comprises teeth 121₁, 121₂, 121₃ and 121₄.

Angular separations are defined between two successive rising tooth edges on the target. These angular separations are known. In particular here:
α₁=240°, and is the angular separation between the respective rising edges of teeth 121₁ and 121₄;
α₂=240°, and is the angular separation between the respective rising edges of teeth 121₂ and 121₁;
α₃=203°, and is the angular separation between the respective rising edges of teeth 121₂ and 121₃;
α₄=37°, and is the angular separation between the respective rising edges of teeth 121₃ and 121₄.

The camshaft sensor 130 is configured to detect the passing of the teeth 121 of the target, and to generate in response a signal comprising rising edges and falling edges, respectively associated with rising edges and falling edges of the teeth.

FIG. 3 schematically illustrates a signal S(t) generated by the camshaft sensor 130. The signal S(t) is a function of time t. The signal S(t) can adopt two values: a low value S₀, when there is no tooth in front of the sensor 130, and a high value S₁, when there is a tooth in front of the sensor 130. Each transition between the low value and the high value of the signal forms a rising edge of the signal, associated with the detection of a rising edge of a tooth of the camshaft target. Each transition between the high value and the low value of the signal forms a falling edge of the signal, associated with the detection of a falling edge of a tooth of the camshaft target.

Time intervals Tₙ, Tₙ₋₁, Tₙ₋₂, Tₙ₋₃ between two successive rising edges of the camshaft signal are defined in the signal S(t).

Each time interval Tₙ (or Tₙ₋₁, Tₙ₋₂, Tₙ₋₃, etc. respectively) corresponds to the time elapsed between two successive detections of rising tooth edges of the target. It will therefore be understood that each time interval Tₙ (or Tₙ₋₁, Tₙ₋₂, Tₙ₋₃, etc. respectively) is linked to one of the angular separations α₁, α₂, α₃, α₄, and to the rotation speed of the camshaft between said two successive detections.

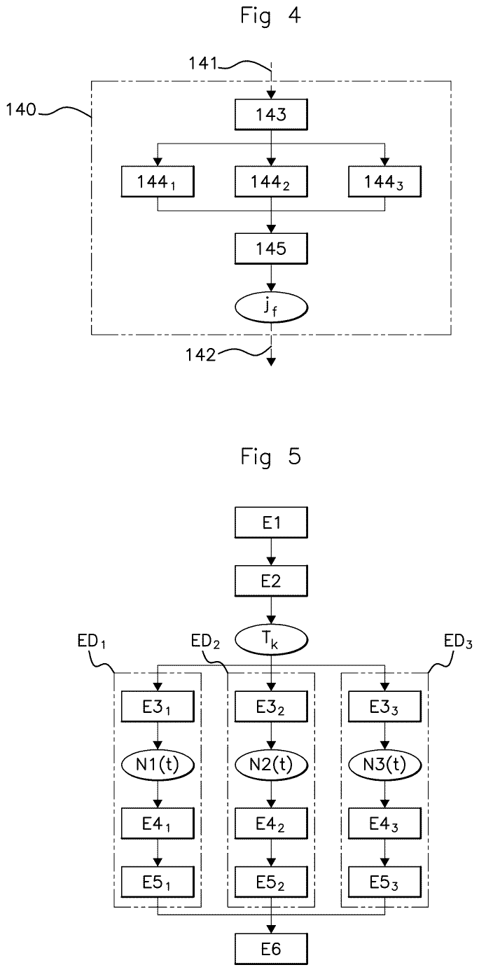

The computer 140 and a method implemented using said computer 140 are described below with reference to FIGS. 4 and 5.

The computer 140 comprises at least one processor and at least one memory. It comprises at least one input interface 141, for receiving input date, here from the camshaft sensor 130, and at least one output interface 142, for providing output data, here a piece of information relating to the tooth of the target currently located in front of the camshaft sensor 130.

The computer 140 comprises an acquisition and pre-processing module 143.

The acquisition and pre-processing module 143 is configured to implement the following steps:
step E1 (FIG. 5): acquiring the signal S(t) generated by a camshaft sensor 130, as said signal S is generated by the camshaft sensor 130; and
step E2 (FIG. 5): calculating the time intervals Tₙ separating two successive rising edges in the signal S(t), as the signal S(t) is acquired by the acquisition and pre-processing module 143.

### First Discrimination Module 144₁:

The computer 140 further comprises a first discrimination module 144₁, configured to receive as an input the time intervals Tₙ, as they are calculated by the module 143, and to implement a first discrimination step (ED₁, FIG. 5), comprising sub-steps E3₁, E4₁ and E5₁ (see FIG. 5).

Sub-step E3₁ consists in determining the current value N1(t), adopted by a first actual ratio N1 that is a function here of the time intervals Tₙ and Tₙ₋₁, where Tₙ is the last time interval supplied by the acquisition and pre-processing module 143 (that is, the most recent in the order of receipt of the time intervals from the module 143), and where Tₙ₋₁ is the time interval immediately preceding the time interval Tₙ in the order of the time intervals supplied by the module 143 (step E3₁).

N1(t) cannot be calculated unless a period necessary for obtaining at least two time intervals Tₙ has elapsed, referred to as the first initiation period.

Sub-step E4₁ consists in comparing said current value of the first actual ratio N1(t), with each of a plurality of first intervals, where each first interval is defined using the value adopted by a first theoretical ratio Rₜₕ₁ (j), where:
the definition of the first theoretical ratio Rₜₕ₁ is similar to the definition of the first actual ratio N1, except that the time intervals Tₙ are replaced by known corresponding angular separations between the rising edges of the teeth 121 of the target, and
each value of the first theoretical ratio Rₜₕ₁ (j) considered is associated with one of a plurality of predetermined hypotheses relating to the index j of the tooth located in front of the camshaft sensor.

Each value of the first theoretical ratio Rₜₕ₁ (j) is therefore a function of two angles αⱼ and αⱼ₋₁, where αⱼ relates to an angular separation between the tooth of index j and the immediately adjacent tooth (for example immediately preceding in an anticlockwise direction), and where αⱼ₋₁ relates to an angular separation between the tooth of index j−1 and the immediately adjacent tooth (for example immediately preceding in an anticlockwise direction). Initially, and in the example of the target illustrated in FIG. 2, the possible hypotheses relating to the index j of the tooth located in front of the sensor are: j=1, or j=2, or j=3, or j=4.

Each hypothesis is associated with a corresponding value of the first theoretical ratio: Rₜₕ₁ (j=1)=R_{th1_1}; Rₜₕ₁ (j=2)=R_{th1_2}; Rₜₕ₁ (j=3)=R_{th1_3}; Rₜₕ₁ (j=4)=R_{th1_4}, and with a respective first interval.

The comparison consists in determining, for each first interval, whether N1(t) is inside or outside said first interval. Each first interval is delimited by bounds that are a function of R_{th1_1}, R_{th1_2}, R_{th1_3}, or R_{th1_4} respectively.

Preferably, the respective bounds of these first intervals are also a function of a tolerance factor k₁. For each hypothesis relating to the index j of the tooth located in front of the sensor, the lower bound V_{inf_1}(j) of the first interval is defined by V_{inf_1}(j)=Rₜₕ₁ (j)/k₁, and the upper bound V_{sup_1}(j) of the first interval is defined by V_{inf_1}(j)=Rₜₕ₁ (j)*k₁.

The result of the comparison therefore indicates, for each interval considered, whether or not N1(t) is inside said first interval, each first interval being associated with a respective value of the first theoretical ratio, and therefore with a hypothesis relating to the index of the tooth currently located in front of the sensor.

Sub-step E5₁ consists in discriminating, as a function of the result of the comparison performed in sub-step E4₁, between tooth indices j that can correspond to the index of the tooth located in front of the camshaft sensor (plausible hypotheses), and tooth indices j that cannot correspond to the index of the tooth located in front of the camshaft sensor (implausible hypotheses). In particular, if the theoretical ratio Rₜₕ₁ (j) of each hypothesis differs excessively from the ratio N1(t), the hypothesis whereby the tooth j is located in front of the sensor is deemed implausible.

One or more hypotheses relating to the index j of the tooth currently located in front of the sensor, at time t, is/are thus eliminated.

### Second Discrimination Module 144₂:

The computer 140 further comprises a second discrimination module 144₂, configured to receive as an input the time intervals Tₙ, as they are calculated by the module 143, and to implement a second discrimination step (ED₂, FIG. 5), comprising sub-steps E3₂, E4₂ and E5₂ (see FIG. 5).

Sub-step E3₂ consists in determining the current value N2(t), adopted by a second actual ratio N2 that is a function here of the time intervals Tₙ, Tₙ₋₁ and Tₙ₋₂, where Tₙ is the last time interval supplied by the acquisition and pre-processing module 143, where Tₙ₋₁ is the time interval immediately preceding Tₙ in the order of the time intervals supplied by the module 143, and where Tₙ₋₂ is the time interval immediately preceding the time interval Tₙ₋₁ in the order of the time intervals supplied by the module 143.

N2(t) cannot be calculated unless a period necessary for obtaining at least three time intervals Tₙ has elapsed, referred to as the second initiation period.

Sub-step E4₂ consists in comparing said current value of the second actual ratio N2(t) with each of a plurality of second intervals, where each second interval is defined using the value adopted by a second theoretical ratio Rₜₕ₂ (j), where:
the definition of the second theoretical ratio Rₜₕ₂ is similar to the definition of the second actual ratio N2, except that the time intervals Tₙ are replaced by known corresponding angular separations between the rising edges of the teeth 121 of the target, and
each value of the first theoretical ratio Rₜₕ₂ (j) considered is associated with one of a plurality of predetermined hypotheses relating to the index j of the tooth located in front of the camshaft sensor.

Each value of the second theoretical ratio Rₜₕ₂ (j) is therefore a function of three angles αⱼ, αⱼ₋₁, and αⱼ₋₂, where αⱼ relates to an angular separation between the tooth of index j and the immediately adjacent tooth (for example immediately preceding in an anticlockwise direction), where αⱼ₋₁ relates to an angular separation between the tooth of index j−1 and the immediately adjacent tooth (for example immediately preceding in an anticlockwise direction), and where αⱼ₋₂ relates to an angular separation between the tooth of index j−2 and the immediately adjacent tooth (for example immediately preceding in an anticlockwise direction).

Here, the possible hypotheses relating to the index j of the tooth located in front of the sensor are: j=1, or j=2, or j=3, or j=4. Each hypothesis is associated with a respective second interval and a corresponding value of the second theoretical ratio: Rₜₕ₂ (j=1)=R_{th2_1}; Rₜₕ₂ (j=2)=R_{th2_2}; Rₜₕ₂ (j=3)=R_{th2_3}; Rₜₕ₂ (j=4)=R_{th2_4}.

The comparison consists in determining, for each second interval, whether N2(t) is inside or outside said second interval. Each second interval is delimited by bounds that are a function of R_{th2_1}, R_{th2_2}, R_{th2_3}, or R_{th2_4} respectively. Again, the respective bounds of these intervals are advantageously a function of a tolerance factor k₂. For each hypothesis relating to the index j of the tooth located in front of the sensor, the lower bound V_{inf_2}(j) of the second interval is defined by V_{inf_2}(j)=Rₜₕ₂ (j)/k₂, and the upper bound V_{sup_2}(j) of the second interval is defined by V_{sup_2}(j)=Rₜₕ₂ (j)*k₂.

The result of the comparison indicates, for each interval considered, whether or not N2(t) is inside said second interval, where each second interval is associated with a respective value of the second theoretical ratio, and therefore with a hypothesis relating to the index of the tooth currently located in front of the sensor.

Sub-step E5₂ consists in discriminating, as a function of the result of the comparison performed in sub-step E4₂, between tooth indices j that can correspond to the index of the tooth located in front of the camshaft sensor, and tooth indices j that cannot correspond to the index of the tooth located in front of the camshaft sensor. In particular, if the theoretical ratio Rₜₕ₂ (j) of each hypothesis differs excessively from the ratio N2(t), the hypothesis whereby the tooth j is located in front of the sensor is deemed implausible. One or more hypotheses relating to the index j of the tooth currently located in front of the sensor, at time t, is/are thus eliminated.

### Third Discrimination Module 144₃:

The computer 140 further comprises a third discrimination module 144₃, configured to receive as an input the time intervals Tₙ, as they are calculated by the module 143, and to implement a third discrimination step (ED₃, FIG. 5), comprising sub-steps E3₃, E4₃ and E5₃ (see FIG. 5).

Sub-step E3₃ consists in determining the current value N3(t), adopted by a third actual ratio N3 that is a function here of the time intervals Tₙ, Tₙ₋₁, Tₙ₋₂ and Tₙ₋₃, where Tₙ is the last time interval supplied by the acquisition and pre-processing module 143, and where Tₙ₋₃, Tₙ₋₂, Tₙ₋₁ and Tₙ succeed each other in that order in the order of the time intervals supplied by the module 143. N3(t) cannot be calculated unless a period necessary for obtaining at least four time intervals Tₙ has elapsed, referred to as the third initiation period.

Sub-step E4₃ consists in comparing said current value of the third actual ratio N3(t) with each of a plurality of third intervals, where each third interval is defined using the value adopted by a third theoretical ratio Rₜₕ₃ (j), where:
the definition of the third theoretical ratio Rₜₕ₃ is similar to the definition of the third actual ratio N3, except that the time intervals Tₙ are replaced by known corresponding angular separations between the rising edges of the teeth 121 of the target, and
each value of the first theoretical ratio Rₜₕ₃ (j) considered is associated with one of a plurality of predetermined hypotheses relating to the index j of the tooth located in front of the camshaft sensor.

Each value of the third theoretical ratio Rₜₕ₃ (j) is therefore a function of four angles αⱼ, αⱼ₋₁ αⱼ₋₂, and αⱼ₋₃, where αⱼ relates to an angular separation between the tooth of index j and the immediately adjacent tooth (for example immediately preceding in an anticlockwise direction), where αⱼ₋₁ relates to an angular separation between the tooth of index j−1 and the immediately adjacent tooth (for example immediately preceding in an anticlockwise direction), where αⱼ₋₂ relates to an angular separation between the tooth of index j−2 and the immediately adjacent tooth (for example immediately preceding in an anticlockwise direction), and where αⱼ₋₃ relates to an angular separation between the tooth of index j−3 and the immediately adjacent tooth (for example immediately preceding in an anticlockwise direction).

Here, the possible hypotheses relating to the index j of the tooth located in front of the sensor are: j=1, or j=2, or j=3, or j=4. Each hypothesis is associated with a respective second interval and a corresponding value of the third theoretical ratio: Rₜₕ₃ (j=1)=R_{th3_1}; Rₜₕ₃ (j=2)=R_{th3_2}; Rₜₕ₃ (j=3)=R_{th3_3}; Rₜₕ₃ (j=4)=R_{th3_4}.

The comparison consists in determining, for each third interval, whether N3(t) is inside or outside said third interval. Each third interval is delimited by bounds that are a function of R_{th3_1}, R_{th3_2}, R_{th3_3}, or R_{th3_4} respectively. Again, the respective bounds of these intervals are advantageously a function of a tolerance factor k₃. For each hypothesis relating to the index j of the tooth located in front of the sensor, the lower bound V_{inf_3}(j) of the third interval is defined by V_{inf_3}(j)=Rₜₕ₃ (j)/k₃, and the upper bound V_{sup_3}(j) of the third interval is defined by V_{sup_3}(j)=Rₜₕ₃ (j)*k₃.

The result of the comparison indicates, for each interval considered, whether or not N3(t) is inside said third interval, where each third interval is associated with a respective value of the third theoretical ratio, and therefore with a hypothesis relating to the index of the tooth currently located in front of the sensor.

Sub-step E5₃ consists in discriminating, as a function of the result of the comparison performed in sub-step E4₃, between tooth indices j that can correspond to the index of the tooth located in front of the camshaft sensor, and tooth indices j that cannot correspond to the index of the tooth located in front of the camshaft sensor. In particular, if the theoretical ratio Rₜₕ₃ (j) of each hypothesis differs excessively from the ratio N3(t), the hypothesis whereby the tooth j is located in front of the sensor is deemed implausible. One or more hypotheses relating to the index j of the tooth currently located in front of the sensor, at time t, is/are thus eliminated.

### Evaluation Module 145:

Finally, the computer 140 according to the invention comprises an evaluation module 145, configured for receiving, from each of the discrimination modules 144₁, 144₂, 144₃, and when it exists, data relating to the tooth indices that can be located in front of the sensor (plausible hypotheses). The evaluation module 145 is configured to compare this data and to deduce therefrom, when possible, the index of the tooth j_{f} actually located in front of the sensor at the time considered (step E5).

The evaluation module 145 is configured to receive data relating to the tooth indices only when such data exists. Due to the aforementioned initiation periods associated with each of the discrimination modules, all of the discrimination modules are not immediately able to supply the evaluation module with such data.

The three discrimination modules 144₁, 144₂, 144₃ are configured to operate in parallel, preferably each independently of the others. Each one makes it possible to eliminate one or more hypotheses. All together, they make it possible to eliminate all of the hypotheses but one, which corresponds to the index of the tooth currently located in front of the sensor.

If applicable, the evaluation module 145 comprises a memory 145, for storing data relating to hypotheses considered plausible at a time t. It is then capable of using this data, at a subsequent time, and in combination with new data linked to the acquisition of a new time interval Tₙ, until all but one of the hypotheses have been eliminated. Hypotheses deemed implausible at a given time are thus no longer considered subsequently (unless an instruction is received to perform a new determination of the index of the tooth located in front of the sensor; see below). The use of results obtained at different times involves, where necessary, offsetting by as many increments as necessary the tooth indices previously considered to be plausible or implausible.

Once the index of the tooth currently located in front of the sensor has been determined, the computer 140 can continue to implement the steps described above, so as to detect the occurrence of an inconsistency between the data supplied by the different discrimination modules. If applicable, the detection of an inconsistency can lead to an instruction to perform a new determination of the index of the tooth currently located in front of the sensor.

When there is only one remaining plausible hypothesis relating to the index of the tooth currently located facing the sensor, synchronization is achieved.

The computer 140 further comprises a starting module (not shown), configured to generate an instruction to start the internal combustion engine when the index of the tooth located in front of the camshaft sensor is obtained as an output from the evaluation module 145. Starting then occurs with a synchronized engine.

Advantageously, N1=Tₙ/Tₙ₋₁, where Tₙ and Tₙ₋₁ are as defined above.

The corresponding first theoretical ratio is then defined by:

Rₜₕ₁(j)=αⱼ/αⱼ₋₁, where j=1, 2, 3, or 4, and where:
αⱼ is the angular separation between the tooth of index j and the immediately preceding tooth in an anticlockwise direction; and
αⱼ₋₁ is the angular separation between the tooth of index j−1 and the immediately preceding tooth in an anticlockwise direction.

Advantageously, N2=(Tₙ₋₁*Tₙ₋₁)/(Tₙ*Tₙ₋₂), where Tₙ, Tₙ₋₁, and Tₙ₋₂ are as defined above.

The corresponding second theoretical ratio is then defined by:

Rₜₕ₂(j)=(αₙ₋₁*αₙ₋₁)/(αₙ*αₙ₋₂), where j=1, 2, 3, or 4, and where:
αⱼ is the angular separation between the tooth of index j and the immediately preceding tooth in an anticlockwise direction;
αⱼ₋₁ is the angular separation between the tooth of index j−1 and the immediately preceding tooth in an anticlockwise direction; and
αⱼ₋₂ is the angular separation between the tooth of index j−2 and the immediately preceding tooth in an anticlockwise direction.

Advantageously, N3=(Tₙ+Tₙ₋₃)/(Tₙ₋₁+Tₙ₋₂), where Tₙ, Tₙ₋₁, Tₙ₋₂, and Tₙ₋₃ are as defined above.

The corresponding third theoretical ratio is then defined by:

Rₜₕ₃(j)=(αₙ+αₙ₋₃)/(αₙ₋₁+αₙ₋₂), where j=1, 2, 3, or 4, and where:
αⱼ is the angular separation between the tooth of index j and the immediately preceding tooth in an anticlockwise direction;
αⱼ₋₁ is the angular separation between the tooth of index j−1 and the immediately preceding tooth in an anticlockwise direction;
αⱼ₋₂ is the angular separation between the tooth of index j−2 and the immediately preceding tooth in an anticlockwise direction; and
αⱼ₋₃ is the angular separation between the tooth of index j−3 and the immediately preceding tooth in an anticlockwise direction.

The invention makes it possible in particular to synchronize the internal combustion engine more quickly than in the prior art, when the crankshaft sensor is defective.

Very often, synchronization is obtained using the first and second discrimination modules only, with the third discrimination module then serving to confirm or refute the result obtained, for optimal robustness of the determination of the angular position of the camshaft.

The starter is then activated for a shorter time, and the first combustions occur more quickly, which means that the motor vehicle can be set in motion more quickly.

Using three discrimination modules (or steps respectively) makes it possible to eliminate all of the implausible edges, while having, for each module (or step respectively), large corresponding intervals, referred to as tolerance ranges. The desired discrimination is obtained due to the use of the three discrimination modules, or steps respectively, rather than by narrow tolerance ranges. This makes it possible to avoid estimation errors regarding the plausible or implausible edges, in particular in the event of strong acceleration or deceleration.

In particular, the respective values of the tolerance factors k_{i, i=1, 2}, or ₃ mentioned above can each be greater than or equal to 2, or greater than or equal to 2.3, or even more. Each discrimination module (or step respectively) then eliminates fewer edges considered to be implausible. However, there is no longer any ambiguity when the edge is rejected. Each module (or step respectively), considered separately, is then extremely robust with respect to very strong accelerations and/or decelerations.

The values adopted by the tolerance factors k₁, k₂, k₃ are a compromise between:
a high value, in order to be robust with respect to strong accelerations and decelerations, and to starts with a low battery and at low temperatures; and
a low value, so that the first, second, or third intervals respectively [Rₜₕ (j)/k; Rₜₕ (j)*k] (tolerance ranges) are as disjoint as possible. This makes it possible to discriminate to the greatest extent possible between the different hypotheses relating to the tooth located in front of the sensor. The more disjoint the tolerance ranges, the better the performance.

Determination is performed by means of tests with a vehicle in actual operating conditions. The three factors k₁, k₂, k₃, as a function of the dynamics of the engine can therefore have three different values.

In any event, the invention makes it possible to use high values of the tolerance factors. The degradation in terms of discrimination by a module considered in isolation is compensated for by the use of a plurality of modules operating in parallel.

Details are given below of an embodiment of the computer and of the method according to the invention. The target shown in FIG. 2 is used as an example. If j=1, then j−1=4=the total number of teeth of the target.

Table for the first discrimination step (k₁=2):

TABLE 1

| index j | 4 | 1 | 2 | 3 |
|---|---|---|---|---|
| αⱼ (°) | 37 | 240 | 240 | 203 |
| Rₜₕ₁₌ αⱼ/αⱼ₋₁ | 0.18 | 6.49 | 1 | 0.85 |
| V_{inf}_{_{—}}₁(j) = Rₜₕ₁(j)*k₁ | 0.37 | 12.97 | 2 | 1.69 |
| Vₛᵤₚ_{_{—}}₁(j) = Rₜₕ₁(j)/k₁ | 0.09 | 3.24 | 0.5 | 0.42 |

This table makes it possible to determine, for each hypothesis relating to the index j of the tooth currently located in front of the sensor, an interval of values [V_{inf1}(j); Vₛᵤₚ₁(j)]. When the value of the first actual ratio N1(t) is inside said interval, this means that the hypothesis whereby the tooth of index j is located in front of the sensor is a plausible hypothesis. Otherwise, said hypothesis is considered to be implausible.

Table for the second discrimination step (k₂=2):

TABLE 2

| index j | 4 | 1 | 2 | 3 |
|---|---|---|---|---|
| αⱼ (°) | 37 | 240 | 240 | 203 |
| Rₜₕ₂(j) = (αₙ₋₁*αₙ₋₁)/(αₙ*αₙ₋₂) | 4.64 | 0.03 | 6.49 | 1.18 |
| V_{inf}_{_{—}}₂(j) = Rₜₕ₂(j)*k₂ | 9.28 | 0.06 | 12.97 | 2.36 |
| Vₛᵤₚ_{_{—}}₂(j) = Rₜₕ₂(j)/k₂ | 2.32 | 0.01 | 3.24 | 0.59 |

This table makes it possible to determine, for each hypothesis relating to the index j of the tooth currently located in front of the sensor, an interval of values [V_{inf2}(j); Vₛᵤₚ₂(j)]. When the value of the second actual ratio N2(t) is inside said interval, this means that the hypothesis whereby the tooth of index j is located in front of the sensor is a plausible hypothesis. Otherwise, said hypothesis is considered to be implausible.

Table for the third discrimination step (k₃=2.3):

TABLE 3

| index j | 4 | 1 | 2 | 3 |
|---|---|---|---|---|
| αⱼ (°) | 37 | 240 | 240 | 203 |
| Rₜₕ₃(j) = (αₙ + αₙ₋₃)/(αₙ₋₁ + αₙ₋₂) | 0.63 | 2 | 1.6 | 0.5 |
| V_{inf}_{_{—}}₃(j) = Rₜₕ₃(j)*k₃ | 1.44 | 4.6 | 3.68 | 1.15 |
| Vₛᵤₚ_{_{—}}₃(j) = Rₜₕ₃(j)/k₃ | 0.27 | 0.87 | 0.70 | 0.22 |

This table makes it possible to determine, for each hypothesis relating to the index j of the tooth currently located in front of the sensor, an interval of values [V_{inf3}(j); Vₛᵤₚ₃(j)]. When the value of the third actual ratio N3(t) is inside said interval, this means that the hypothesis whereby the tooth of index j is located in front of the sensor is a plausible hypothesis. Otherwise, said hypothesis is considered to be implausible.

Experimentally, the following results are obtained:
on the first rising tooth edge detected: too soon to obtain a result;
on the second rising tooth edge detected: calculation of a first time interval T₁;
on the third rising tooth edge detected: calculation of a second time interval T₂, and calculation of a current value of the first actual ratio N1 making it possible to eliminate implausible hypotheses. If applicable, the tooth actually located in front of the sensor is determined at this stage;
on the fourth rising tooth edge detected: calculation of a third time interval T₃, calculation of a new current value of the first actual ratio N1 making it possible to eliminate implausible hypotheses, and calculation of a current value of the second actual ratio N2 also making it possible to eliminate implausible hypotheses. If applicable, the tooth actually located in front of the sensor is determined at this stage. A determination obtained previously can also be confirmed, relating to the tooth actually located in front of the sensor;
on the fifth rising tooth edge detected: calculation of a fourth time interval T₄, calculation of a new current value of the first actual ratio N1 making it possible to eliminate implausible hypotheses, calculation of a new current value of the second actual ratio N2 also making it possible to eliminate implausible hypotheses, and calculation of a current value of the third actual ratio N3 making it possible to eliminate implausible hypotheses. If applicable, the tooth actually located in front of the sensor is determined at this stage. A determination obtained previously can also be confirmed, relating to the tooth actually located in front of the sensor.

If applicable, the detection of additional rising tooth edges is necessary, in order to determine the tooth actually located in front of the sensor at the time considered. Said determination can use data previously obtained and relating to the valid or invalid hypotheses, taking into account the offsetting of one tooth on each detection of a new rising tooth edge.

In any event, it will be understood that the invention, in that it uses a plurality of discrimination modules simultaneously, makes it possible to obtain a reliable result much more quickly than in the prior art, particularly in situations of strong acceleration or deceleration.

The invention uses three different definitions of the actual ratio, or theoretical ratio respectively, which do not use the same tooth edges. Combining the different definitions of the ratios makes it possible to eliminate all of the implausible hypotheses so that only one remains.

It can be shown that the invention makes it possible to determine the tooth currently located in front of the sensor more quickly than in the prior art, with for example a gain of at least 300 ° C RK (angle of rotation of the crankshaft), that is, a gain of more than 240 ms at 200 rpm.

The application of the invention is illustrated with a target having four unevenly distributed teeth. The application of the invention is not however limited to such a target, and it can be applied with any type of target having unevenly distributed teeth, advantageously targets with a large number of teeth, for example six teeth or even more.

The invention further relates to a computer program comprising program code instructions for carrying out the steps of the method according to the invention, when said program is operating on a computer. The program can be loaded onto an on-board computer or an engine control system of a motor vehicle.

Another object of the invention relates to a motor vehicle comprising a synchronization system according to the invention.

1. A computer for a system for synchronizing an internal combustion engine, said system comprising:
a camshaft provided with a camshaft target, the camshaft target having a plurality of teeth unevenly distributed on its perimeter, each tooth being associated with a predetermined index making it possible to identify it; and
a camshaft sensor, configured to detect the passing of the teeth, and to generate in response a signal comprising rising edges and falling edges respectively associated with rising edges and falling edges of the teeth;
said computer comprising an acquisition and pre-processing module, configured to acquire the signal generated by the camshaft sensor, and to calculate time intervals Tₙ separating two rising edges, or falling edges respectively, immediately succeeding each other in said signal;
the computer being characterized in that it further comprises
i/ a first discrimination module, configured for:
determining a current value adopted by a first actual ratio (N1) that is a function of a first set of time intervals Tₙ;
comparing said current value of the first actual ratio (N1) with each of a plurality of predetermined first intervals, each first interval being defined as a function of the respective value adopted by a first theoretical ratio (Rₜₕ₁), where the definition of the first theoretical ratio (Rₜₕ₁) is similar to the definition of the first actual ratio (N1) except that the time intervals Tₙ are replaced by known corresponding angular separations between the rising edges or falling edges respectively of the teeth of the camshaft target, and where each value of the first theoretical ratio (Rₜₕ₁) considered is associated with one of a plurality of predetermined hypotheses relating to the index of the tooth located in front of the camshaft sensor; and
as a function of the result of each comparison, discriminating between tooth indices that can correspond to the index of the tooth located in front of the camshaft sensor, and tooth indices that cannot correspond to the index of the tooth located in front of the camshaft sensor;
ii/ a second discrimination module, configured for implementing the same steps as the first discrimination module, except that these steps use a second actual ratio (N2) that is a function of a second set of time intervals Tₙ, and second intervals defined as a function of a second theoretical ratio (Rₜₕ₂), where the definition of the second theoretical ratio (Rₜₕ₂) is similar to the definition of the second actual ratio (N2) except that the time intervals Tₙ are replaced by known corresponding angular separations between the rising edges or falling edges respectively of the teeth of the camshaft target, and where the second set of time intervals contains a higher number of time intervals Tₙ than the first set of time intervals;
iii/ a third discrimination module, configured for implementing the same steps as the first discrimination module, except that these steps use a third actual ratio (N3) that is a function of a third set of time intervals Tₙ, and third intervals defined as a function of a third theoretical ratio (Rₜₕ₃), where the definition of the third theoretical ratio (Rₜₕ₃) is similar to the definition of the third actual ratio (N3) except that the time intervals Tₙ are replaced by known corresponding angular separations between the rising edges or falling edges respectively of the teeth of the camshaft target, and where the third set of time intervals contains a higher number of time intervals Tₙ than the second set of time intervals; and
an evaluation module, configured for receiving, from the first, second, and third discrimination modules and when it exists, data relating to the tooth indices that can or cannot correspond to the index of the tooth located in front of the camshaft sensor, and for comparing this data so as to deduce therefrom the index of the tooth located in front of the camshaft sensor.

2. The computer as claimed in claim 1, characterized in that each first, second, or third interval respectively is delimited by a lower bound and an upper bound, where:
the lower bound is equal to the quotient of the respective value over the first, second, or third theoretical ratio (Rₜₕ₁, Rₜₕ₂, Rₜₕ₃) respectively, divided by a first, second, or third tolerance factor respectively; and
the upper bound is equal to the product of the respective value by the first, second, or third theoretical ratio (Rₜₕ₁, Rₜₕ₂, Rₜₕ₃) respectively, multiplied by the first, second, or third tolerance factor respectively.

3. The computer as claimed in claim 2, characterized in that at least one of the first, second, or third tolerance factors respectively is greater than or equal to 2.3.

4. The computer as claimed in claim 1, characterized in that it further comprises a starting module, configured to generate an instruction to start the internal combustion engine when the index of the tooth located in front of the camshaft sensor is obtained as an output from the evaluation module.

5. The computer as claimed in claim 1, characterized in that the first, second, and third discrimination modules are configured to operate together in parallel.

6. The computer as claimed in claim 1, characterized in that the second actual ratio (N2) is defined by N2=(Tₙ₋₁*Tₙ₋₁)/(Tₙ*Tₙ₋₂),
where Tₙ relates to the last time interval in the signal received by the acquisition and pre-processing module;
where Tₙ₋₁ relates to the time interval immediately preceding the time interval Tₙ, in the signal received by the acquisition and pre-processing module;
where Tₙ₋₂ relates to the time interval immediately preceding the time interval Tₙ₋₁, in the signal received by the acquisition and pre-processing module.

7. The computer as claimed in claim 6, characterized in that:
the first actual ratio (N1) is defined by N1=Tₙ/Tₙ₋₁; and
the third actual ratio (N3) is defined by N3=(Tₙ+Tₙ₋₃)/(Tₙ₋₁+Tₙ₋₂), where Tₙ₋₃ relates to the time interval immediately preceding the time interval Tₙ₋₂, in the signal received by the acquisition and pre-processing module.

8. A system for synchronizing an internal combustion engine, said system comprising:
a camshaft provided with a camshaft target, the camshaft target having a plurality of teeth unevenly distributed on its perimeter, each tooth being associated with a predetermined index making it possible to identify it; and
a camshaft sensor, configured to detect the passing of the teeth, and to generate in response a signal comprising rising edges and falling edges respectively associated with rising edges and falling edges of the teeth; and
a computer as claimed in claim 1.

9. A method for determining the angular position of a camshaft target, where said camshaft target is rigidly mounted on a camshaft and has a plurality of teeth unevenly distributed on its perimeter, each tooth being associated with a predetermined index making it possible to identify it, the method comprising the following steps:
acquiring a signal generated by a camshaft sensor, said sensor being configured to detect the passing of the teeth of the camshaft target and to generate in response a signal comprising rising edges and falling edges respectively associated with rising edges and falling edges of the teeth; and
calculating the time intervals Tₙ separating two rising edges, or falling edges respectively, immediately succeeding each other in said signal;
characterized in that if further comprises the following steps:
i/ a first discrimination step, consisting in:
determining the current value adopted by a first actual ratio (N1) that is a function of a first set of time intervals Tₙ;
comparing said current value of the first actual ratio (N1) with each of a plurality of predetermined first intervals, each first interval being defined as a function of the respective value adopted by a first theoretical ratio (Rₜₕ₁), where the definition of the first theoretical ratio (Rₜₕ₁) is similar to the definition of the first actual ratio (N1) except that the time intervals Tₙ are replaced by known corresponding angular separations between the rising edges or falling edges respectively of the teeth of the camshaft target, and where each value of the first theoretical ratio (Rₜₕ₁) considered is associated with one of a plurality of predetermined hypotheses relating to the index of the tooth located in front of the camshaft sensor; and
as a function of the result of the comparison, discriminating between tooth indices that can correspond to the index of the tooth located in front of the camshaft sensor, and tooth indices that cannot correspond to the index of the tooth located in front of the camshaft sensor;
ii/ a second discrimination step, implementing the same steps as the first discrimination step, except that these steps use a second actual ratio (N2) that is a function of a second set of time intervals Tₙ, and second intervals defined as a function of a second theoretical ratio (Rₜₕ₂), where the definition of the second theoretical ratio (Rₜₕ₂) is similar to the definition of the second actual ratio (N2) except that the time intervals Tₙ are replaced by known corresponding angular separations between the rising edges or falling edges respectively of the teeth of the camshaft target, and where the second set of time intervals contains a higher number of time intervals Tₙ than the first set of time intervals;
iIi/ a third discrimination step, implementing the same steps as the first discrimination module, except that these steps use a third actual ratio (N3) that is a function of a third set of time intervals Tₙ, and third intervals defined as a function of a third theoretical ratio (Rₜₕ₃), where the definition of the third theoretical ratio (Rₜₕ₃) is similar to the definition of the third actual ratio (N3) except that the time intervals Tₙ are replaced by known corresponding angular separations between the rising edges or falling edges respectively of the teeth of the camshaft target, and where the third set of time intervals contains a higher number of time intervals Tₙ than the second set of time intervals;
the method then comprising an evaluation step consisting in comparing, when it exists, data relating to the tooth indices that can or cannot correspond to the index of the tooth located in front of the camshaft sensor, this data being obtained in the first, second, and third discrimination steps, and deducing therefrom the index of the tooth located in front of the camshaft sensor.

10. The method as claimed in claim 9, characterized in that it further comprises a step of generating an instruction to start the internal combustion engine, when the index of the tooth located in front of the camshaft sensor has been determined in the preceding steps.

11. The method as claimed in claim 9, characterized in that the first, second, and third discrimination steps are implemented in parallel.

12. The method as claimed in claim 9, characterized in that the second actual ratio (N2) is defined by N2=(Tₙ₋₁*Tₙ₋₁)/(Tₙ*Tₙ₋₂),
where Tₙ relates to the last time interval acquired, in the signal acquired from the camshaft sensor;
where Tₙ₋₁ relates to the time interval immediately preceding the time interval Tₙ, in the signal acquired from the camshaft sensor;
where Tₙ₋₂ relates to the time interval immediately preceding the time interval Tₙ₋₁, in the signal acquired from the camshaft sensor.

13. The method as claimed in claim 12, characterized in that:
the first actual ratio (N1) is defined by N1=Tₙ/Tₙ₋₁; and
the third actual ratio (N3) is defined by N3=(Tₙ+Tₙ₋₃)/(Tₙ₋₁+Tₙ₋₂), where Tₙ₋₃ relates to the time interval immediately preceding the time interval Tₙ₋₂, in the signal acquired from the camshaft sensor.

14. A computer program comprising program code instructions for carrying out the steps of the synchronization method as claimed in claim 9, when said program is operating on a computer.

15. A motor vehicle comprising a synchronization system as claimed in claim 8.
